(19) United States
(12) Patent Application Publication
(10) Pub. No.: US 2024/0357106 A1
(43) Pub. Date: Oct. 24, 2024

(54) A METHOD, AN APPARATUS AND A COMPUTER PROGRAM PRODUCT FOR VIDEO ENCODING AND VIDEO DECODING

(71) Applicant: Nokia Technologies Oy, Espoo (FI)

(72) Inventors: Sujeet Shyamsundar MATE, Tampere (FI); Miska Matias HANNUKSELA, Tampere (FI); Kashyap KAMMACHI SREEDHAR, Tampere (FI); Emre Baris AKSU, Tampere (FI)

(21) Appl. No.: 18/682,311

(22) PCT Filed: Jul. 15, 2022
(86) PCT No.: PCT/FI2022/050499

§ 371 Date: Feb. 8, 2024

(30) Foreign Application Priority Data
Aug. 17, 2021 (FI) 20215869

(51) Int. Cl. H04N 19/119; H04N 19/169; H04N 19/174

(52) U.S. Cl. CPC H04N 19/119; H04N 19/174; H04N 19/188

(57) ABSTRACT

The embodiments relate to apparatuses and methods for subpicture encoding. According to an embodiment a method for a sender apparatus comprises receiving (901) image data; partitioning (902) the image data into subpictures; generating (903) a transmission packet comprising said subpictures and a packet header; inserting (904) into the transmission packet a subpicture header comprising information regarding the subpictures; and transmitting (905) the transmission packet to be delivered to a receiver apparatus.

### TECHNICAL FIELD

The present solution generally relates to video encoding and video decoding.

### BACKGROUND

This section is intended to provide a background or context to the invention that is recited in the claims. The description herein may include concepts that could be pursued but are not necessarily ones that have been previously conceived or pursued. Therefore, unless otherwise indicated herein, what is described in this section is not prior art to the description and claims in this application and is not admitted to be prior art by inclusion in this section.

A video coding system may comprise an encoder that transforms an input video into a compressed representation suited for storage/transmission and a decoder that can uncompress the compressed video representation back into a viewable form. The encoder may discard some information in the original video sequence in order to represent the video in a more compact form, for example, to enable the storage/transmission of the video information at a lower bitrate than otherwise might be needed.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

The disclosure describes a subpicture header for real time protocol (RTP) based carriage of video content. In an embodiment, the subpicture header is included in an RTP header extension. In an embodiment, the subpicture header is included in an RTP payload header. The video content may be coded with the Versatile Video Coding (VVC a.k.a. H.266 a.k.a. H.266/VVC) standard but embodiments are not limited to VVC.

In an embodiment, the subpicture header is included in a user datagram protocol (UDP) packet carrying secure reliable transport protocol (SRT) packets. The SRT packets comprise an SRT header and payload, wherein the subpicture header may be included in the SRT header, for example.

In an embodiment, the subpicture header is included in a frame of a QUIC protocol, which may be used to carry RUSH packets (Reliable (unreliable) streaming protocol).

The RTP, SRT and RUSH are used as examples but the principles regarding the inclusion of the subpicture header may also be implemented with other low latency transport mechanisms as well.

In an embodiment of the disclosure, the subpicture header is used for one or more packetization modes if the number of subpictures in a coded video sequence is at least 2. In an embodiment, the use of the subpicture header is declared as a sender property in SDP (a session description protocol) or any other declarative session description format. In an embodiment, the use of the subpicture header is negotiated with SDP offer/answer mechanism or any other session negotiation protocol (e.g., only declarative session description for RTSP/RTP streaming or for other unicast/multicast/broadcast low latency streaming). In an embodiment with request based approach typically used in web based systems, the subpicture header capability is discovered, requested or updated with a restful application programming interface (API). In another embodiment, the use of subpicture is described only for the session declaration such unicast or multicast streaming.

In an embodiment of the disclosure, the header comprises one or more of following components to assist in efficient subpicture handling operation without diving deep into the bitstream:
subpicture identifier (ID),
type of subpictures,
indication of the start of a subpicture,
indication of the end of a subpicture.

The subpicture types can be, for example, independent subpictures, dependent subpicture, substitute subpicture. There may be e.g. one type which is reserved for possible future extensions.

In an embodiment, one of the bits in the header can be used to indicate a “picture complete” flag. This may help to explicitly indicate the last subpicture for a given access unit (AU).

In another embodiment, to facilitate the inclusion of subpicture header only when an additional benefit of efficient subpicture extraction is required, a new session description parameter subpic-header-cap is disclosed. The subpic-header-cap is included for each offered video stream. Inclusion of the the subpic-header-cap attribute in a send-only offer or a send-recv offer indicates that the subpicture header functionality is supported by the sender. The receiver can retain the attribute if it intends to use the subpicture header. The attribute can be dropped if the receiver does not intend to use the capability. In an embodiment, a receiver initiates SDP offer/answer which includes the subpic-header-cap attribute in a recv-only offer to indicate that the sender should use the subpicture header functionality. The sender can retain the subpic-header-cap attribute in its response to indicate that it intends to include the subpicture header in the transmitted bitstream.

In another embodiment, the session description can include the ability to also use a constrained length subpicture ID in the offer (if it is supported), with a reduced permissible subpicture ID length, in order to achieve reduced overhead with inclusion of the subpicture header. The receiver can respond with or without the subpic-header-cap like described above. In addition, the receiver can retain or reject the constrained subpicture ID length. This can be implemented as subpic-header-cap=0/1. If the value of subpic-header-cap is equal to 1, the sender supports constrained subpicture ID length. A subpic-header-cap equal to 0 or no value can be interpreted as no support for constrained subpicture ID length. It should be noted that these numbers 0/1 are only examples and other indications may also be used to indicate whether the sender supports or does not support the constrained subpicture ID length.

In accordance with an embodiment of the disclosure, there is provided a subpicture header to augment the current packetization structure. The subpicture header may be added for all the packetization modes i.e. single NAL (network abstraction layer) unit packet, Aggregation Packet (AP) and Fragmentation Unit (FU).

Various aspects include a method, an apparatus and a computer readable medium comprising a computer program stored therein, which are characterized by what is stated in the independent claims. Various embodiments are disclosed in the dependent claims.

According to a first aspect, there is provided a sender apparatus comprising
means for receiving image data;
means for partitioning the image data into subpictures;
means for generating a transmission packet comprising said subpictures and a packet header;
means for inserting into the transmission packet a subpicture header comprising information regarding the subpictures; and
means for transmitting the transmission packet to be delivered to a receiver apparatus.

According to an embodiment, the subpicture header comprises one or more of the following fields:
an identifier of the subpicture;
a type of the subpicture;
an indication of a start of the subpicture;
an indication of an end of the subpicture;
an indication whether NAL units followed by the subpicture header are parameter sets required for independent decoding by a separate decoder instance;
an indication whether the NAL unit is applicable to all subpictures in the coded video sequence;
an indication of a last subpicture for an access unit.

According to an embodiment, the means for generating a transmission packet are configured to generate a real time protocol packet comprising an RTP header and an RTP payload header for Versatile Video Coding (VVC).

According to an embodiment, the means for generating a transmission packet are configured to generate a secure reliable transport protocol (SRT) packet comprising an SRT header and an SRT payload header.

According to an embodiment, the means for generating a transmission packet are configured to generate a frame of a QUIC protocol comprising a RUSH packet and including the subpicture header in the RUSH packet.

According to a second aspect, there is provided a method comprising:
receiving image data;
partitioning the image data into subpictures;
generating a transmission packet comprising said subpictures and a packet header; inserting into the transmission packet a subpicture header comprising information regarding the subpictures; and transmitting the transmission packet to be delivered to a receiver apparatus.

According to a third aspect, there is provided an apparatus comprising at least one processor; and at least one memory including computer program code the at least one memory and the computer program code configured to, with the at least one processor, cause the apparatus to perform at least the following:
receive image data;
partition the image data into subpictures;
generate a transmission packet comprising said subpictures and a packet header; insert into the transmission packet a subpicture header comprising information regarding the subpictures; and transmit the transmission packet to be delivered to a receiver apparatus.

According to a fourth aspect, there is provided a computer program comprising computer readable program code which, when executed by at least one processor; cause the apparatus to perform at least the following:
receive image data;
partition the image data into subpictures;
generate a transmission packet comprising said subpictures and a packet header; insert into the transmission packet a subpicture header comprising information regarding the subpictures; and
transmit the transmission packet to be delivered to a receiver apparatus.

According to a fifth aspect, there is provided a forwarding apparatus comprising:
means for receiving a transmission packet having a subpicture header comprising information regarding subpictures of image data;
means for examining the subpicture header;
means for extracting one or more subpictures from the transmission packet based on the subpicture header;
means for generating a bitstream from the one or more subpictures; and means for transmitting the bitstream to be delivered to a receiver apparatus.

According to a sixth aspect, there is provided a method comprising:
receiving a transmission packet having a subpicture header comprising information regarding subpictures of image data;
examining the subpicture header;
extracting one or more subpictures from the transmission packet based on the subpicture header;
generating a bitstream from the one or more subpictures; and transmitting the bitstream to be delivered to a receiver apparatus.

According to a seventh aspect, there is provided an apparatus comprising at least one processor; and at least one memory including computer program code the at least one memory and the computer program code configured to, with the at least one processor, cause the apparatus to perform at least the following:
receive a transmission packet having a subpicture header comprising information regarding subpictures of image data;
examine the subpicture header;
extract one or more subpictures from the transmission packet based on the subpicture header;
generate a bitstream from the one or more subpictures; and
transmit the bitstream to be delivered to a receiver apparatus.

According to an eighth aspect, there is provided a computer program comprising computer readable program code which, when executed by at least one processor; cause the apparatus to perform at least the following:
receive a transmission packet having a subpicture header comprising information regarding subpictures of image data;
examine the subpicture header;
extract one or more subpictures from the transmission packet based on the subpicture header;
generate a bitstream from the one or more subpictures; and
transmit the bitstream to be delivered to a receiver apparatus.

The utilization of the subpicture header described in this disclosure may have some advantages such as efficient implementation of a selective forwarding unit (SFU), minimizing a need to dive deep into a bitstream is minimized, efficient extraction of subpictures from the bitstream is the motivation, just to mention only few. This can also be beneficial for ROI (region of interest) based rendering where only a subset of the received bitstream is extracted and decoded, one such example being rendering a high resolution video on a lower resolution display. Such a scenario is expected when a high resolution video stream is received for rendering on 8K TV, but the same bitstream is also reused by a second screen mobile device when the user is moving around to follow the game.

### DESCRIPTION OF THE DRAWINGS

In the following, various embodiments will be described in more detail with reference to the appended drawings, in which

FIG. 1a shows an example of an encoding method;

FIG. 1b shows an example of a decoding method;

FIG. 2a shows an Illustration of a structure of a subpicture header, in accordance with an embodiment;

FIG. 2b shows an Illustration of a structure of a subpicture header, in accordance with another embodiment;

FIG. 3 shows an illustration of a single NAL packet with subpicture header included, in accordance with an embodiment;

FIG. 4a shows an illustration of an aggregation packet with a single subpicture header for the aggregation packet, in accordance with an embodiment;

FIG. 4b shows an illustration of an aggregation packet which includes a subpicture header for each NAL unit or an aggregation unit, in accordance with an embodiment

FIG. 5a shows an illustration of an aggregation packet with a single subpicture header, in accordance with an embodiment;

FIG. 5b shows an illustration of an aggregation packet with a subpicture header for each NAL unit, in accordance with an embodiment;

FIG. 6 shows an illustration of a fragmentation unit packet with a subpicture header in the fragmentation unit with a start of a NAL unit, in accordance with an embodiment;

FIG. 7 shows an illustration of a real time protocol header extension with a payload header, a DONL and a single subpicture header, in accordance with an embodiment;

FIG. 8 shows as a simplified block diagram an example of a selective forwarding unit receiving a coded video sequence comprising multiple subpictures, in accordance with an embodiment;

FIG. 9a is a flowchart illustrating a method for a sender apparatus according to an embodiment;

FIG. 9b is a flowchart illustrating a method for a forwarding apparatus according to an embodiment;

FIG. 10a shows as a simplified block diagram a user equipment according to an embodiment; and

FIG. 10b shows an apparatus according to an embodiment.

### DESCRIPTION OF EXAMPLE EMBODIMENTS

The present embodiments are related to Versatile Video Coding (VVC), and in particular to VVC content creation based on receiver bitstream extraction requirements or decoding capabilities. However, the present embodiments are not limited to VVC but may be applied with any video coding scheme or format that provides a picture partitioning mechanism similar to subpictures of VVC.

The following description and drawings are illustrative and are not to be construed as unnecessarily limiting. The specific details are provided for a thorough understanding of the disclosure. However, in certain instances, well-known or conventional details are not described in order to avoid obscuring the description. References to one or an embodiment in the present disclosure can be, but not necessarily are, reference to the same embodiment and such references mean at least one of the embodiments.

Reference in this specification to “one embodiment” or “an embodiment” means that a particular feature, structure, or characteristic described in connection with the embodiment in included in at least one embodiment of the disclosure.

The Advanced Video Coding standard (which may be abbreviated AVC or H.264/AVC) was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organization for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, each integrating new extensions or features to the specification. These extensions include Scalable Video Coding (SVC) and Multiview Video Coding (MVC).

The High Efficiency Video Coding standard (which may be abbreviated HEVC or H.265/HEVC) was developed by the Joint Collaborative Team—Video Coding (JCT-VC) of VCEG and MPEG. The standard is published by both parent standardization organizations, and it is referred to as ITU-T Recommendation H.265 and ISO/IEC International Standard 23008-2, also known as MPEG-H Part 2 High Efficiency Video Coding (HEVC). Extensions to H.265/HEVC include scalable, multiview, three-dimensional, and fidelity range extensions, which may be referred to as SHVC, MV-HEVC, 3D-HEVC, and REXT, respectively.

The Versatile Video Coding standard (which may be abbreviated VVC, H.266, or H.266/VVC) was developed by the Joint Video Experts Team (JVET), which is a collaboration between the ISO/IEC MPEG and ITU-T VCEG. Extensions to VVC are presently under development.

Some key definitions, bitstream and coding structures are described in this section as an example of a video encoder, decoder, encoding method, decoding method, and a bitstream structure, wherein the embodiments may be implemented.

Video codec may comprise an encoder that transforms the input video into a compressed representation suited for storage/transmission and a decoder that can uncompress the compressed video representation back into a viewable form. The compressed representation may be referred to as a bitstream or a video bitstream. A video encoder and/or a video decoder may also be separate from each other, i.e. they need not to form a codec. The encoder may discard some information in the original video sequence in order to represent the video in a more compact form (that is, at lower bitrate).

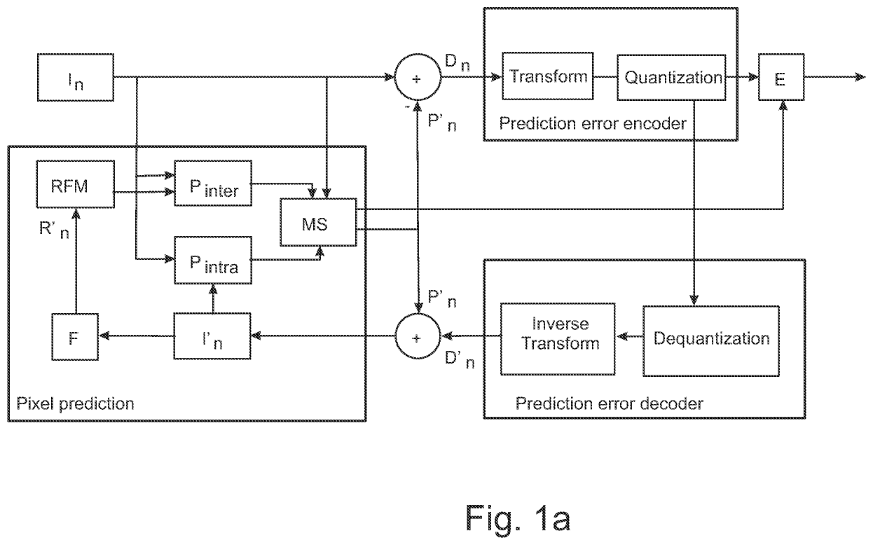

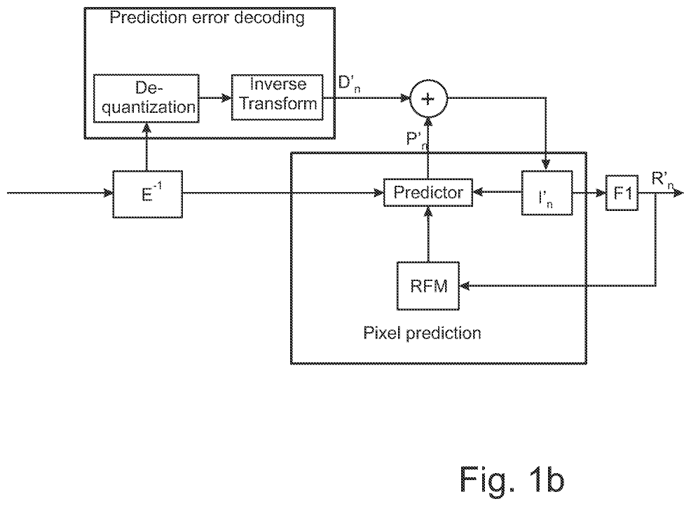

An example of an encoding process is illustrated in FIG. 1a. FIG. 1a illustrates an image to be encoded (In); a predicted representation of an image block (P′ₙ); a prediction error signal (Dₙ); a reconstructed prediction error signal (D′ₙ); a preliminary reconstructed image (I′ₙ); a final reconstructed image (R′ₙ); a transform (T) and inverse transform (T⁻¹); a quantization (Q) and inverse quantization (Q⁻¹); entropy encoding (E); a reference frame memory (RFM); inter prediction (Pinter); intra prediction (Pᵢₙₜᵣₐ); mode selection (MS) and filtering (F). An example of a decoding process is illustrated in FIG. 1b. FIG. 1b illustrates a predicted representation of an image block (P′ₙ); a reconstructed prediction error signal (D′ₙ); a preliminary reconstructed image (I′ₙ); a final reconstructed image (R′ₙ); an inverse transform (T⁻¹); an inverse quantization (Q⁻¹); an entropy decoding (E⁻¹); a reference frame memory (RFM); a prediction (either inter or intra) (P); and filtering (F).

Hybrid video codecs, for example H.264/AVC, HEVC and VVC, may encode the video information in two phases. At first, pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). In the first phase, predictive coding may be applied, for example, as so-called sample prediction and/or so-called syntax prediction.

In the sample prediction, pixel or sample values in a certain picture area or “block” are predicted. These pixel or sample values can be predicted, for example, using one or more of motion compensation or intra prediction mechanisms.

Motion compensation mechanisms (which may also be referred to as inter prediction, temporal prediction or motion-compensated temporal prediction or motion-compensated prediction or MCP) involve finding and indicating an area in one of the previously encoded video frames that corresponds closely to the block being coded. One of the benefits of the inter prediction is that they may reduce temporal redundancy.

In intra prediction, pixel or sample values can be predicted by spatial mechanisms. Intra prediction involves finding and indicating a spatial region relationship, and it utilizes the fact that adjacent pixels within the same picture are likely to be correlated. Intra prediction can be performed in spatial or transform domain, i.e., either sample values or transform coefficients can be predicted. Intra prediction may be exploited in intra coding, where no inter prediction is applied.

In the syntax prediction, which may also be referred to as parameter prediction, syntax elements and/or syntax element values and/or variables derived from syntax elements are predicted from syntax elements (de)coded earlier and/or variables derived earlier. Non-limiting examples of syntax prediction are provided below.

In motion vector prediction, motion vectors e.g. for inter and/or inter-view prediction may be coded differentially with respect to a block-specific predicted motion vector. In many video codecs, the predicted motion vectors are created in a predefined way, for example by calculating the median of the encoded or decoded motion vectors of the adjacent blocks. Another way to create motion vector predictions, sometimes referred to as advanced motion vector prediction (AMVP), is to generate a list of candidate predictions from adjacent blocks and/or co-located blocks in temporal reference pictures and signalling the chosen candidate as the motion vector predictor. In addition to predicting the motion vector values, the reference index of previously coded/decoded picture can be predicted. The reference index is typically predicted from adjacent blocks and/or co-located blocks in temporal reference picture. Differential coding of motion vectors is typically disabled across slice boundaries.

The block partitioning, e.g. from coding tree units (CTUs) to coding units (CUs) and down to prediction units (PUs), may be predicted. Partitioning is a process a set is divided into subsets such that each element of the set may be in one of the subsets. Pictures may be partitioned into CTUs with a maximum size of 128×128, although encoders may choose to use a smaller size, such as 64×64. A coding tree unit (CTU) may be first partitioned by a quaternary tree (a.k.a. quadtree) structure. Then the quaternary tree leaf nodes can be further partitioned by a multi-type tree structure. There are four splitting types in multi-type tree structure, vertical binary splitting, horizontal binary splitting, vertical ternary splitting, and horizontal ternary splitting. The multi-type tree leaf nodes are called coding units (CUs). CU, PU and TU (transform unit) have the same block size, unless the CU is too large for the maximum transform length. A segmentation structure for a CTU is a quadtree with nested multi-type tree using binary and ternary splits, i.e. no separate CU, PU and TU concepts are in use except when needed for CUs that have a size too large for the maximum transform length. A CU can have either a square or rectangular shape.

In filter parameter prediction, the filtering parameters e.g. for sample adaptive offset may be predicted.

Prediction approaches using image information from a previously coded image can also be called as inter prediction methods which may also be referred to as temporal prediction and motion compensation. Prediction approaches using image information within the same image can also be called as intra prediction methods.

Secondly, the prediction error, i.e. the difference between the predicted block of pixels and the original block of pixels, is coded. This may be done by transforming the difference in pixel values using a specified transform (e.g. Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size of transmission bitrate).

In many video codecs, including H.264/AVC and HEVC, motion information is indicated by motion vectors associated with each motion compensated image block. Each of these motion vectors represents the displacement of the image block in the picture to be coded (in the encoder) or decoded (at the decoder) and the prediction source block in one of the previously coded or decoded images (or pictures). H.264/AVC and HEVC, as many other video compression standards, a picture is divided into a mesh of rectangles, for each of which a similar block in one of the reference pictures is indicated for inter prediction. The location of the prediction block is coded as a motion vector that indicates the position of the prediction block relative to the block being coded.

Video coding standards may specify the bitstream syntax and semantics as well as the decoding process for error-free bitstreams, whereas the encoding process might not be specified, but encoders may just be required to generate conforming bitstreams. Bitstream and decoder conformance can be verified with the Hypothetical Reference Decoder (HRD). The standards may contain coding tools that help in coping with transmission errors and losses, but the use of the tools in encoding may be optional and decoding process for erroneous bitstreams might not have been specified.

A syntax element may be defined as an element of data represented in the bitstream. A syntax structure may be defined as zero or more syntax elements present together in the bitstream in a specified order.

An elementary unit for the input to an encoder and the output of a decoder, respectively, in most cases is a picture. A picture given as an input to an encoder may also be referred to as a source picture, and a picture decoded by a decoder may be referred to as a decoded picture or a reconstructed picture.

The source and decoded pictures are each comprised of one or more sample arrays, such as one of the following sets of sample arrays:
Luma (Y) only (monochrome).
Luma and two chroma (YCbCr or YCgCo).
Green, Blue and Red (GBR, also known as RGB).
Arrays representing other unspecified monochrome or tri-stimulus color samplings (for example, YZX, also known as XYZ).

In the following, these arrays may be referred to as luma (or L or Y) and chroma, where the two chroma arrays may be referred to as Cb and Cr; regardless of the actual color representation method in use. The actual color representation method in use can be indicated e.g. in a coded bitstream e.g. using the Video Usability Information (VUI) syntax of HEVC or alike. A component may be defined as an array or single sample from one of the three sample arrays (luma and two chroma) or the array or a single sample of the array that compose a picture in monochrome format.

A picture may be defined to be either a frame or a field. A frame comprises a matrix of luma samples and possibly the corresponding chroma samples. A field is a set of alternate sample rows of a frame and may be used as encoder input, when the source signal is interlaced. Chroma sample arrays may be absent (and hence monochrome sampling may be in use) or chroma sample arrays may be subsampled when compared to luma sample arrays.

Some chroma formats may be summarized as follows:
In monochrome sampling there is only one sample array, which may be nominally considered the luma array.
In 4:2:0 sampling, each of the two chroma arrays has half the height and half the width of the luma array.
In 4:2:2 sampling, each of the two chroma arrays has the same height and half the width of the luma array.
In 4:4:4 sampling when no separate color planes are in use, each of the two chroma arrays has the same height and width as the luma array.

Coding formats or standards may allow to code sample arrays as separate color planes into the bitstream and respectively decode separately coded color planes from the bitstream. When separate color planes are in use, each one of them is separately processed (by the encoder and/or the decoder) as a picture with monochrome sampling.

An elementary unit for the output of encoders of some coding formats, such as HEVC and VVC, and the input of decoders of some coding formats, such as HEVC and VVC, is a Network Abstraction Layer (NAL) unit. For transport over packet-oriented networks or storage into structured files, NAL units may be encapsulated into packets or similar structures.

NAL units can be categorized into Video Coding Layer (VCL) NAL units and non-VCL NAL units.

VCL NAL units may for example be coded slice NAL units.

The Versatile Video Coding (VVC) includes new coding tools compared to HEVC or H.264/AVC. These coding tools are related to, for example, intra prediction; inter-picture prediction; transform, quantization and coefficients coding; entropy coding; in-loop filter; screen content coding; 360-degree video coding; high-level syntax and parallel processing. Some of these tools are briefly described in the following:

### Intra Prediction

67 intra modes with wide angles mode extension
Block size and mode dependent 4 tap interpolation filter
Position dependent intra prediction combination (PDPC)
Cross component linear model intra prediction (CCLM)
Multi-reference line intra prediction
Intra sub-partitions
Weighted intra prediction with matrix multiplication

### Inter-Picture Prediction

Block motion copy with spatial, temporal, history-based, and pairwise average merging candidates
Affine motion inter prediction
sub-block based temporal motion vector prediction
Adaptive motion vector resolution
8×8 block-based motion compression for temporal motion prediction
High precision ( 1/16 pel) motion vector storage and motion compensation with 8-tap interpolation filter for luma component and 4-tap interpolation filter for chroma components
Triangular partitions
Combined intra and inter prediction
Merge with motion vector difference (MVD) (MMVD)
Symmetrical MVD coding
Bi-directional optical flow
Decoder side motion vector refinement
Bi-prediction with CU-level weight

### Transform, Quantization and Coefficients Coding

Multiple primary transform selection with DCT2, DST7 and DCT8
Secondary transform for low frequency zone
Sub-block transform for inter predicted residual
Dependent quantization with max QP increased from 51 to 63
Transform coefficient coding with sign data hiding
Transform skip residual coding

### Entropy Coding

Arithmetic coding engine with adaptive double windows probability update

### In Loop Filter

In-loop reshaping
Deblocking filter with strong longer filter
Sample adaptive offset
Adaptive Loop Filter

### Screen Content Coding:

Current picture referencing with reference region restriction

### 360-Degree Video Coding

Horizontal wrap-around motion compensation

### High-Level Syntax and Parallel Processing

Reference picture management with direct reference picture list signalling
Tile groups with rectangular shape tile groups

In VVC, each picture may be partitioned into coding tree units (CTUs). A CTU may be split into smaller CUs using quaternary tree structure. Each CU may be partitioned using quad-tree and nested multi-type tree including ternary and binary split. There are specific rules to infer partitioning in picture boundaries. The redundant split patterns are disallowed in nested multi-type partitioning.

In some video coding schemes, such as HEVC and VVC, a picture is divided into one or more tile rows and one or more tile columns. The partitioning of a picture to tiles forms a tile grid that may be characterized by a list of tile column widths and a list of tile row heights. A tile may be required to contain an integer number of elementary coding blocks, such as CTUs in HEVC and VVC. Consequently, tile column widths and tile row heights may be expressed in the units of elementary coding blocks, such as CTUs in HEVC and VVC.

A tile may be defined as a sequence of elementary coding blocks, such as CTUs in HEVC and VVC, that covers one “cell” in the tile grid, i.e., a rectangular region of a picture. Elementary coding blocks, such as CTUs, may be ordered in the bitstream in raster scan order within a tile.

Some video coding schemes may allow further subdivision of a tile into one or more bricks, each of which consisting of a number of CTU rows within the tile. A tile that is not partitioned into multiple bricks may also be referred to as a brick. However, a brick that is a true subset of a tile is not referred to as a tile.

In some video coding schemes, such as H.264/AVC, HEVC and VVC, a coded picture may be partitioned into one or more slices. A slice may be decodable independently of other slices of a picture and hence a slice may be considered as a preferred unit for transmission. In some video coding schemes, such as H.264/AVC, HEVC, and VVC, a video coding layer (VCL) NAL unit contains exactly one slice.

A slice may comprise an integer number of elementary coding blocks, such as CTUs in HEVC or VVC.

In some video coding schemes, such as VVC, a slice contains an integer number of tiles of a picture or an integer number of CTU rows of a tile.

In some video coding schemes, two modes of slices may be supported, namely the raster-scan slice mode and the rectangular slice mode. In the raster-scan slice mode, a slice contains a sequence of tiles in a tile raster scan of a picture. In the rectangular slice mode, a slice contains an integer number of tiles of a picture or an integer number of CTU rows of a tile that collectively form a rectangular region of the picture.

A non-VCL NAL unit may be for example one of the following types: a video parameter set (VPS), a sequence parameter set (SPS), a picture parameter set (PPS), an adaptation parameter set (APS), a supplemental enhancement information (SEI) NAL unit, a picture header (PH) NAL unit, an end of sequence NAL unit, an end of bitstream NAL unit, or a filler data NAL unit. Some non-VCL NAL units, such as parameter sets and picture headers, may be needed for the reconstruction of decoded pictures, whereas many of the other non-VCL NAL units might not be necessary for the reconstruction of decoded sample values.

Some coding formats specify parameter sets that may carry parameter values needed for the decoding or reconstruction of decoded pictures. Some examples of different types of parameter sets are briefly described in this paragraph. A video parameter set (VPS) may include parameters that are common across multiple layers in a coded video sequence or describe relations between layers. Parameters that remain unchanged through a coded video sequence (in a single-layer bitstream) or in a coded layer video sequence may be included in a sequence parameter set (SPS). In addition to the parameters that may be needed by the decoding process, the sequence parameter set may optionally contain video usability information (VUI), which includes parameters that may be important for buffering, picture output timing, rendering, and resource reservation. A picture parameter set (PPS) contains such parameters that are likely to be unchanged in several coded pictures. A picture parameter set may include parameters that can be referred to by the coded image segments of one or more coded pictures. A header parameter set (HPS) has been proposed to contain such parameters that may change on picture basis. In VVC, an Adaptation Parameter Set (APS) may comprise parameters for decoding processes of different types, such as adaptive loop filtering or luma mapping with chroma scaling.

A parameter set may be activated when it is referenced e.g. through its identifier. For example, a header of an image segment, such as a slice header, may contain an identifier of the PPS that is activated for decoding the coded picture containing the image segment. A PPS may contain an identifier of the SPS that is activated, when the PPS is activated. An activation of a parameter set of a particular type may cause the deactivation of the previously active parameter set of the same type.

Instead of or in addition to parameter sets at different hierarchy levels (e.g. sequence and picture), video coding formats may include header syntax structures, such as a sequence header or a picture header. A sequence header may precede any other data of the coded video sequence in the bitstream order. A picture header may precede any coded video data for the picture in the bitstream order.

Video coding specifications may enable the use of supplemental enhancement information (SEI) messages or alike. Some video coding specifications include SEI NAL units, and some video coding specifications contain both prefix SEI NAL units and suffix SEI NAL units. A prefix SEI NAL unit can start a picture unit or alike; and a suffix SEI NAL unit can end a picture unit or alike. Hereafter, an SEI NAL unit may equivalently refer to a prefix SEI NAL unit or a suffix SEI NAL unit. An SEI NAL unit includes one or more SEI messages, which are not required for the decoding of output pictures but may assist in related processes, such as picture output timing, post-processing of decoded pictures, rendering, error detection, error concealment, and resource reservation.

Several SEI messages are specified in H.264/AVC, H.265/HEVC, H.266/VVC, and H.274/VSEI standards, and the user data SEI messages enable organizations and companies to specify SEI messages for specific use. The standards may contain the syntax and semantics for the specified SEI messages but a process for handling the messages in the recipient might not be defined. Consequently, encoders may be required to follow the standard specifying a SEI message when they create SEI message(s), and decoders might not be required to process SEI messages for output order conformance. One of the reasons to include the syntax and semantics of SEI messages in standards is to allow different system specifications to interpret the supplemental information identically and hence interoperate. It is intended that system specifications can require the use of particular SET messages both in the encoding end and in the decoding end, and additionally the process for handling particular SEI messages in the recipient can be specified.

The phrase along the bitstream (e.g. indicating along the bitstream) or along a coded unit of a bitstream (e.g. indicating along a coded tile) may be used in claims and described embodiments to refer to transmission, signaling, or storage in a manner that the “out-of-band” data is associated with but not included within the bitstream or the coded unit, respectively. The phrase decoding along the bitstream or along a coded unit of a bitstream or alike may refer to decoding the referred out-of-band data (which may be obtained from out-of-band transmission, signaling, or storage) that is associated with the bitstream or the coded unit, respectively. For example, the phrase along the bitstream may be used when the bitstream is contained in a container file, such as a file conforming to the ISO Base Media File Format, and certain file metadata is stored in the file in a manner that associates the metadata to the bitstream, such as boxes in the sample entry for a track containing the bitstream, a sample group for the track containing the bitstream, or a timed metadata track associated with the track containing the bitstream.

A coded picture is a coded representation of a picture.

A bitstream may be defined as a sequence of bits, which may in some coding formats or standards be in the form of a NAL unit stream or a byte stream, that forms the representation of coded pictures and associated data forming one or more coded video sequences. A first bitstream may be followed by a second bitstream in the same logical channel, such as in the same file or in the same connection of a communication protocol. An elementary stream (in the context of video coding) may be defined as a sequence of one or more bitstreams. In some coding formats or standards, the end of the first bitstream may be indicated by a specific NAL unit, which may be referred to as the end of bitstream (EOB) NAL unit and which is the last NAL unit of the bitstream.

A coded video sequence (CVS) may be defined as such a sequence of coded pictures in decoding order that is independently decodable and is followed by another coded video sequence or the end of the bitstream.

The subpicture feature of VVC allows for partitioning of the VVC bitstream in a flexible manner as multiple rectangles representing subpictures, where each subpicture comprises one or more slices. In other words, a subpicture may be defined as a rectangular region of one or more slices within a picture, wherein the one or more slices are complete. Consequently, a subpicture consists of one or more slices that collectively cover a rectangular region of a picture. The slices of a subpicture may be required to be rectangular slices.

In VVC, the feature of subpictures enables efficient extraction of subpicture(s) from one or more bitstream and merging the extracted subpictures to form another bitstream without excessive penalty in compression efficiency and without modifications of VCL NAL units (i.e. slices).

The use of subpictures in a coded video sequence (CVS), however, requires appropriate configuration of the encoder and other parameters such as SPS/PPS and so on. In VVC, a layout of partitioning of a picture to subpictures may be indicated in and/or decoded from an SPS. A subpicture layout may be defined as a partitioning of a picture to subpictures. In VVC, the SPS syntax indicates the partitioning of a picture to subpictures by providing for each subpicture syntax elements indicative of: the x and y coordinates of the top-left corner of the subpicture, the width of the subpicture, and the height of the subpicture, in CTU units. One or more of the following properties may be indicated (e.g. by an encoder) or decoded (e.g. by a decoder) or inferred (e.g. by an encoder and/or a decoder) for the subpictures collectively or per each subpicture individually: i) whether or not a subpicture is treated like a picture in the decoding process (or equivalently, whether or not subpicture boundaries are treated like picture boundaries in the decoding process); in some cases, this property excludes in-loop filtering operations, which may be separately indicated/decoded/inferred; ii) whether or not in-loop filtering operations are performed across the subpicture boundaries. When a subpicture is treated like a picture in the decoding process, any references to sample locations outside the subpicture boundaries are saturated to be within the subpicture boundaries. This may be regarded being equivalent to padding samples outside subpicture boundaries with the boundary sample values for decoding the subpicture. Consequently, motion vectors may be allowed to cause references outside subpicture boundaries in a subpicture that is extractable.

An independent subpicture (a.k.a. an extractable subpicture) may be defined as a subpicture i) with subpicture boundaries that are treated as picture boundaries and ii) without loop filtering across the subpicture boundaries. A dependent subpicture may be defined as a subpicture that is not an independent subpicture.

In video coding, an isolated region may be defined as a picture region that is allowed to depend only on the corresponding isolated region in reference pictures and does not depend on any other picture regions in the current picture or in the reference pictures. The corresponding isolated region in reference pictures may be for example the picture region that collocates with the isolated region in a current picture. A coded isolated region may be decoded without the presence of any picture regions of the same coded picture.

A VVC subpicture with boundaries treated like picture boundaries may be regarded as an isolated region.

A motion-constrained tile set (MCTS) is a set of tiles such that the inter prediction process is constrained in encoding such that no sample value outside the MCTS, and no sample value at a fractional sample position that is derived using one or more sample values outside the motion-constrained tile set, is used for inter prediction of any sample within the motion-constrained tile set. Additionally, the encoding of an MCTS is constrained in a manner that no parameter prediction takes inputs from blocks outside the MCTS. For example, the encoding of an MCTS is constrained in a manner that motion vector candidates are not derived from blocks outside the MCTS. In HEVC, this may be enforced by turning off temporal motion vector prediction of HEVC, or by disallowing the encoder to use the temporal motion vector prediction (TMVP) candidate or any motion vector prediction candidate following the TMVP candidate in a motion vector candidate list for prediction units located directly left of the right tile boundary of the MCTS except the last one at the bottom right of the MCTS.

In general, an MCTS may be defined to be a tile set that is independent of any sample values and coded data, such as motion vectors, that are outside the MCTS. An MCTS sequence may be defined as a sequence of respective MCTSs in one or more coded video sequences or alike. In some cases, an MCTS may be required to form a rectangular area. It should be understood that depending on the context, an MCTS may refer to the tile set within a picture or to the respective tile set in a sequence of pictures. The respective tile set may be, but in general need not be, collocated in the sequence of pictures. A motion-constrained tile set may be regarded as an independently coded tile set, since it may be decoded without the other tile sets. An MCTS is an example of an isolated region.

The subpicture feature of VVC may be regarded as an improvement over motion constrained tile sets. VVC support for real-time conversational and low latency use cases will be important to fully exploit the functionality and end user benefit with modern networks (e.g., ULLRC 5G networks, OTT delivery, etc.). VVC encoding and decoding is computationally complex. Consequently, bitstream creation, partitioning and annotation which minimizes manipulation of the bitstream and processing in compressed domain is highly desired. This is a remarkable enabler for various network infrastructure elements such as MANE (Media Aware Network Elements), MCU (Multiparty Conferencing Unit)/MRF (Media Resource Function), SFU (Selective Forwarding Unit) for scalable deployments. With increasing computational complexity the end-user devices consuming the content are heterogeneous for example devices supporting single decoding instances to devices supporting multiple decoding instances and more sophisticated devices having multiple decoders. Consequently, the system carrying the payload should be able to support a variety of scenarios for scalable deployments. There has been rapid growth in the resolution (e.g., 8K) of the video consumed via CE (Consumer Electronics) devices (e.g., TVs, mobile devices) which can benefit with the ability to execute multiple parallel decoders. One example use case can be parallel decoding for low latency unicast or multicast delivery of 8K VVC encoded content.

A substitute subpicture may be defined as a subpicture that is not intended for displaying. A substitute subpicture may be included in the bitstream in order to have a complete partitioning of a picture to subpictures. A substitute subpicture may be included in the picture when no other subpictures are available for a particular subpicture location in the subpicture layout. In an example, a substitute subpicture may be included in a coded picture when another subpicture is not received early enough, e.g. based on a decoding time of a picture, or a buffer occupancy level falls below a threshold.

In an example, a substitute subpicture may be made available and delivered to a receiver or player prior to it is potentially merged into a bitstream to be decoded. For example, a substitute subpicture may be delivered to a receiver at session setup. In another example, a substitute subpicture may be generated by a receiver or player.

Encoding of a substitute subpicture may comprise encoding one or more slices. According to an example, a substitute subpicture is coded as an intra slice that represents a constant colour. The coded residual signal may be absent or zero in a substitute subpicture. According to an example, a substitute subpicture is encoded as an intra random access point (IRAP) subpicture. The IRAP subpicture may be coded with reference to a picture parameter set (PPS) with pps_rpl_info_in_ph_flag equal to 1 as specified in H.266/VVC.

Real-time Transport Protocol (RTP) is widely used for real-time transport of timed media such as audio and video. RTP may operate on top of the User Datagram Protocol (UDP), which in turn may operate on top of the Internet Protocol (IP). RTP is specified in Internet Engineering Task Force (IETF) Request for Comments (RFC) 3550, available from www.ietf.org/rfc/rfc3550.txt. In RTP transport, media data is encapsulated into RTP packets. Typically, each media type or media coding format has a dedicated RTP payload format.

RTP is designed to carry a multitude of multimedia formats, which permits the development of new formats without revising the RTP standard. To this end, the information required by a specific application of the protocol is not included in the generic RTP header. For a class of applications (e.g., audio, video), an RTP profile may be defined. For a media format (e.g., a specific video coding format), an associated RTP payload format may be defined. Every instantiation of RTP in a particular application may require a profile and payload format specifications. For example, an RTP profile for audio and video conferences with minimal control is defined in RFC 3551, and an Audio-Visual Profile with Feedback (AVPF) is specified in RFC 4585. The profile may define a set of static payload type assignments, and/or may use a dynamic mechanism for mapping between a payload format and a payload type (PT) value using Session Description Protocol (SDP). The latter mechanism is used for newer video codec such as RTP payload format for H.264 defined in RFC 6184 or RTP Payload Format for HEVC defined in RFC 7798.

An RTP session is an association among a group of participants communicating with RTP. It is a group communications channel which can potentially carry a number of RTP streams. An RTP stream is a stream of RTP packets comprising media data. An RTP stream is identified by an SSRC belonging to a particular RTP session. SSRC refers to either a synchronization source or a synchronization source identifier that is the 32-bit SSRC field in the RTP packet header. A synchronization source is characterized in that all packets from the synchronization source form part of the same timing and sequence number space, so a receiver device may group packets by synchronization source for playback. Examples of synchronization sources include the sender of a stream of packets derived from a signal source such as a microphone or a camera, or an RTP mixer. Each RTP stream is identified by a SSRC that is unique within the RTP session.

The RTP specification recommends even port numbers for RTP, and the use of the next odd port number for the associated RTCP session. A single port can be used for RTP and RTCP in applications that multiplex the protocols.

RTP packets are created at the application layer and handed to the transport layer for delivery. Each unit of RTP media data created by an application begins with the RTP packet header.

The RTP header has a minimum size of 12 bytes. After the header, optional header extensions may be present. This is followed by the RTP payload, the format of which is determined by the particular class of application. The fields in the RTP header comprise the following:
Version: (2 bits) Indicates the version of the protocol.
P (Padding): (1 bit) Used to indicate if there are extra padding bytes at the end of the RTP packet.
X (Extension): (1 bit) Indicates presence of an extension header between the header and payload data. The extension header is application or profile specific.
CC (CSRC count): (4 bits) Contains the number of CSRC identifiers that follow the SSRC.
M (Marker): (1 bit) Signaling used at the application level in a profile-specific manner. If it is set, it means that the current data has some special relevance for the application.
PT (Payload type): (7 bits) Indicates the format of the payload and thus determines its interpretation by the application.
Sequence number: (16 bits) The sequence number is incremented for each RTP data packet sent and is to be used by the receiver to detect packet loss and to accommodate out-of-order delivery.
Timestamp: (32 bits) Used by the receiver to play back the received samples at appropriate time and interval. When several media streams are present, the timestamps may be independent in each stream. The granularity of the timing is application specific. For example, video streams typically use a 90 kHz clock. The clock granularity is one of the details that is specified in the RTP profile for an application.
SSRC: (32 bits) Synchronization source identifier uniquely identifies the source of a stream. The synchronization sources within the same RTP session will be unique.
CSRC: (32 bits each) Contributing source IDs enumerate contributing sources to a stream which has been generated from multiple sources.
Header extension: (optional, presence indicated by Extension field) The first 32-bit word contains a profile-specific identifier (16 bits) and a length specifier (16 bits) that indicates the length of the extension in 32-bit units, excluding the 32 bits of the extension header. The extension header data follows.

Real-time control protocol (RTCP) enables monitoring of the data delivery in a manner scalable to large multicast networks and provides minimal control and identification functionality. An RTCP stream accompanies an RTP stream. RTCP sender report (SR) packets are sent from the sender to the receiver (i.e., in the same direction as the media in the respective RTP stream). RTCP receiver report (RR) packets are sent from the receiver to the sender.

A point-to-point RTP session is consists of two endpoints, communicating using unicast. Both RTP and RTCP traffic are conveyed endpoint to endpoint.

Many multipoint audio-visual conferences operate utilizing a centralized unit, which may be called Multipoint Control Unit (MCU). An MCU may implement the functionality of an RTP translator or an RTP mixer. An RTP translator may be a media translator that may modify the media inside the RTP stream. A media translator may for example decode and re-encode the media content (i.e. transcode the media content). An RTP mixer is a middlebox that aggregates multiple RTP streams that are part of a session by generating one or more new RTP streams. An RTP mixer may manipulate the media data. One common application for a mixer is to allow a participant to receive a session with a reduced amount of resources compared to receiving individual RTP streams from all endpoints. A mixer can be viewed as a device terminating the RTP streams received from other endpoints in the same RTP session. Using the media data carried in the received RTP streams, a mixer generates derived RTP streams that are sent to the receiving endpoints.

The Session Description Protocol (SDP) may be used to convey media details, transport addresses, and other session description metadata, when initiating multimedia teleconferences, voice-over-IP calls, or other multimedia delivery sessions. SDP is a format for describing multimedia communication sessions for the purposes of announcement and invitation. SDP does not deliver any media streams itself but may be used between endpoints e.g. for negotiation of network metrics, media types, and/or other associated properties. SDP is extensible for the support of new media types and formats.

SDP uses attributes to extend the core protocol. Attributes can appear within the Session or Media sections and are scoped accordingly as session-level or media-level. New attributes can be added to the standard through registration with IANA. A media description may contain any number of “a=” lines (attribute-fields) that are media description specific. Session-level attributes convey additional information that applies to the session as a whole rather than to individual media descriptions.

The “fmtp” attribute of SDP allows parameters that are specific to a particular format to be conveyed in a way that SDP does not have to understand them. The format must be one of the formats specified for the media. Format-specific parameters, semicolon separated, may be any set of parameters required to be conveyed by SDP and given unchanged to the media tool that will use this format. At most one instance of this attribute is allowed for each format.

The SDP offer/answer model specifies a mechanism in which endpoints achieve a common operating point of media details and other session description metadata when initiating the multimedia delivery session. One endpoint, the offerer, sends a session description (the offer) to the other endpoint, the answerer. The offer contains all the media parameters needed to exchange media with the offerer, including codecs, transport addresses, and protocols to transfer media. When the answerer receives an offer, it elaborates an answer and sends it back to the offerer. The answer contains the media parameters that the answerer is willing to use for that particular session. SDP may be used as the format for the offer and the answer.

An initial SDP offer includes zero or more media streams, wherein each media stream is described by an “m=” line and its associated attributes. Zero media streams implies that the offerer wishes to communicate, but that the streams for the session will be added at a later time through a modified offer.

A direction attribute may be used in the SDP offer/answer model as follows. If the offerer wishes to only send media on a stream to its peer, it marks the stream as sendonly with the “a=sendonly” attribute. If the offerer wishes to only receive media from its peer, it marks the stream as recvonly. If the offerer wishes to both send and receive media with its peer, it may include an “a=sendrecv” attribute in the offer, or it may omit it, since sendrecv is the default.

In the SDP offer/answer model, the list of media formats for each media stream comprises the set of formats (codecs and any parameters associated with the codec, in the case of RTP) that the offerer is capable of sending and/or receiving (depending on the direction attributes). If multiple formats are listed, it means that the offerer is capable of making use of any of those formats during the session and thus the answerer may change formats in the middle of the session, making use of any of the formats listed, without sending a new offer. For a sendonly stream, the offer indicates those formats the offerer is willing to send for this stream. For a recvonly stream, the offer indicates those formats the offerer is willing to receive for this stream. For a sendrecv stream, the offer indicates those codecs or formats that the offerer is willing to send and receive with. The list of media formats in the “m=” line is listed in the order preference, the first entry in the list being the most preferred.

SDP may be used for declarative purposes, e.g. for describing a stream available to be received over a streaming session. For example, SDP may be included in Real Time Streaming Protocol (RTSP).

A Multipurpose Internet Mail Extension (MIME) is an extension to an email protocol which makes it possible to transmit and receive different kinds of data files on the Internet, for example video, audio, images, and software. An internet media type is an identifier used on the Internet to indicate the type of data that a file contains. Such internet media types may also be called as content types. Several MIME type/subtype combinations exist that can contain different media formats. Content type information may be included by a transmitting entity in a MIME header at the beginning of a media transmission. A receiving entity thus may need to examine the details of such media content to determine if the specific elements can be rendered given an available set of codecs. Especially when the end system has limited resources, or the connection to the end system has limited bandwidth, it may be helpful to know from the content type alone if the content can be rendered.

One of the original motivations for MIME is the ability to identify the specific media type of a message part. However, due to various factors, it is not always possible from looking at the MIME type and subtype to know which specific media formats are contained in the body part or which codecs are indicated in order to render the content. Optional media parameters may be provided in addition to the MIME type and subtype to provide further details of the media content.

Optional media parameters may be conveyed in SDP, e.g. using the “a=fmtp” line of SDP. Optional media parameters may be specified to apply for certain direction attribute(s) with an SDP offer/answer and/or for declarative purposes. Optional media parameters may be specified not to apply for certain direction attribute(s) with an SDP offer/answer and/or for declarative purposes. Semantics of optional media parameters may depend on and may differ based on which direction attribute(s) of an SDP offer/answer they are used with and/or whether they are used for declarative purposes.

One example of an optional media parameter specified for VVC is sprop-sps. When present, sprop-sps conveys SPS NAL units of the bitstream for out-of-band transmission of SPSs. The value of sprop-sps may be defined as a comma-separated list, where each list element is a base64 representation (as defined in RFC 4648) of an SPS NAL unit.

For low latency delivery, MCUs in general and SFUs in particular provide important functionality to handle the VVC bitstream in a compressed format. There is a need to enable easy access to the bitstream information which enables selective bitstream extraction without any heavy computational processing. Furthermore, there is a need to have a mechanism which allows for extraction of subpictures from the bitstream without performing a deep dive into the bitstream and make it possible to perform the appropriate extraction without deep knowledge about the VVC codec functionality.

For consumption devices equipped with multiple decoders or having the capabilities of multiple decoding instances, the applications can make use of the subpicture feature in VVC. It would help if the sender knew about the receiver intent and capability. The required encoding configuration should be mutually agreed to inform the encoder to create bitstream which can be optimally utilized by one or more decoders in the receiver. Appropriate encoder configuration to create subpictures which can leverage multiple decoders (when available) is not possible with the current VVC RTP payload draft. This is an important feature for high resolution content such as 8K. There can be scenarios where a mix of dependent and independent subpictures are required for content consumption for example switching between different picture aspect ratios (16:9<->4:3), and region of interest based rendering.

RTP payload format for VVC shares the basic design with NAL unit-based RTP payload formats of H.264 Video Coding, Scalable Video Coding, HEVC, for example. VVC also inherits the basic systems and transport interfaces designs from HEVC and H.264, such as NAL-unit-based syntax structure, the hierarchical syntax and data unit structure, the SEI message mechanism, and the video buffering model based on the hypothetical reference decoder (HRD).

The video parameter set (VPS) pertains to a coded video sequences (CVS) of multiple layers covering the same range of access units, and includes, among other information decoding dependency expressed as information for reference picture list construction of enhancement layers. The sequence parameter set (SPS) contains syntax elements pertaining to a coded layer video sequence (CLVS), which is a group of pictures belonging to the same layer, starting with a random access point, and followed by pictures that may depend on each other, until the next random access point pictures.

Profile, tier and level syntax structures in VPS and SPS contain profile, tier, level information, for layers associated with one or more output layer sets specified by the VPS and for any layer that refers to the SPS, respectively. An output layer set may be defined as A set of layers for which one or more layers are specified as the output layers. An output layer may be defined as a layer of an output layer set that is output. The decoding process may be defined in a manner that when both a picture is marked as an output picture in the bitstream or inferred to be an output picture and the picture is in an output layer of an output layer set at which the decoder is operating, the decoded picture is output by the decoding process. If a picture is not marked or inferred to be an output picture or the picture is not in an output layer of an output layer set at which the decoder is operating, the decoded picture is not output by the decoding process.

The current draft of RTP Payload Format for Versatile Video Coding (VVC) does not cover the functionality of subpictures, which is an important feature of VVC.

A draft RTP payload format for VVC defines following processes required for transport of VVC coded data over RTP:
usage of RTP header with the payload format;
packetization of VVC coded NAL units into RTP packets, using three types of payload structure: a single NAL unit packet, aggregation packet, and fragment packet
transmission of VVC NAL units of the same bitstream within a single RTP stream;
media type parameters to be used with the session description protocol (SDP);
usage of RTCP feedback messages.

A single NAL unit packet may carry only a single NAL unit in an RTP payload. The NAL header type field in the RTP payload header is equal to the original NAL unit type in the bitstream. An aggregation packet may be used to aggregate multiple NAL units into a single RTP payload. A fragmentation packet (a.k.a a fragmentation unit) may be used to fragment a single NAL unit over multiple RTP packets.

However, VVC RTP payload format does not define any specific support for subpictures creation control or depacketization or extraction, nor parallel decoding of subpictures from the VVC bitstream. In addition, the current version of IETF draft has no description of sender and receiver's signalling for the desired bitstream partitioning with subpictures. Currently the IETF draft does not carry any information for handling of subpictures. Overall, the support for efficient subpicture extraction from the VVC bitstream is not present for RTP-based carriage.

Frame marking RTP header extension is an IETF draft in progress to convey information about frames which are not accessible to the network elements due to lack of access to decryption keys. However, the IETF draft does not address the scenario of accessing subpictures from a high level in case of encrypted RTP payload.

HEVC supports parallel decoding approaches which consists of slices, tiles and WPP (wavefront parallel processing). The HEVC standard and consequently RFC 7798 does not support the use of multiple decoder instances for decoding partitions of a bitstream. In contrast, VVC decoder implementations can use of one or more decoder instances to decode extractable subpicture sequences like independent VVC bitstreams in order to leverage availability of additional resources in the current receiver devices. This support for decoding a single picture with multiple decoder instances is feasible in case of coded video sequence (CVS) comprising multiple independent subpictures.

HEVC RTP payload format (RFC 7798) has the parameter dec-parallel-cap to indicate the need for parallelism. Due to the permissiveness of in-picture prediction between neighboring treeblock rows within a picture, the required inter-processor/inter-core communication to enable in-picture prediction can be substantial. This is one implication of using WPP for parallelism. If loop filtering across tile boundaries is turned off, then no inter-process communication is needed. If loop filtering across tile boundaries is enabled, then either loop filtering across tile boundaries is done after all tiles have been decoded, or decoding of tiles is performed in raster scan order, and loop filtering is carried out across boundaries of decoded tiles (in both sides of the boundary).

Neither RFC 7798 nor any other document provides support for indicating the need or possibility for having multiple decoder instance support for decoding extractable subpicture sequences like independent VVC bitstreams. Neither RFC 7798 nor any other document provides support to enable parallel decoding such that the output of the individual decoders need not wait for all the constituent subpictures. Such support would allow for low latency content reception and/or decoding, which can be of use in new applications such as machine learning based content analysis.

The present embodiments provide a new subpicture header for RTP-based carriage of video. In an embodiment, the subpicture header is included in an RTP header extension. In an embodiment, the subpicture header is included in an RTP payload header. Embodiments may be used with, but are not limited to, VVC.

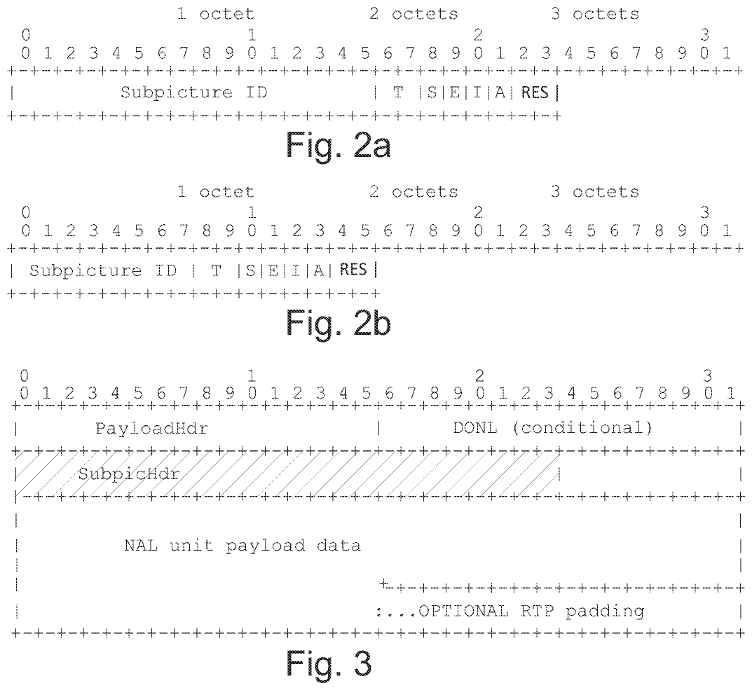

According to an embodiment, the subpicture header is of 3 octets length. The details of the subpicture header (henceforth also SubpicHdr) is described in the following and illustrated in FIG. 2a. It needs to be understood that embodiments and the syntax illustrated in FIG. 2a may be similarly realized with subpicture header syntax of a length not equal to 3 octets. Similarly, it needs to be understood that while specific field lengths in bits are provided with embodiments, the embodiments may be similarly realized other field lengths.

According to an embodiment, the subpicture header comprises an identifier of the subpicture (Subpicture ID) to indicate the ID of the subpicture that is contained in the packet within the scope of the subpicture header. The subpicture identifier has a certain length. In the example of FIG. 2a the length of the identifier is 16 bits.

According to an embodiment, a subpicture header comprises a type field (referred to as the T field in FIG. 2a). The type field contains indication of the type of subpictures. In the example of FIG. 2a the size of the type field is 2 bits, wherein at most 4 different types could be indicated. In accordance with an embodiment, the types comprise an Independent subpicture, and a Dependent subpicture. An Independent subpicture may be defined as a subpicture with boundaries treated like picture boundaries. A Dependent subpicture may be defined as a subpicture with boundaries not treated like picture boundaries. An Independent subpicture may be regarded as an isolated region, whereas a Dependent subpicture is not. In accordance with an embodiment, the types also comprise a Substitute subpicture. Unused value(s) of the type field may be reserved for possible future extension.

According to an embodiment, a subpicture header comprises a field, e.g. 1 bit, for indicating a start of the subpicture. This field may be referred to as the S field. In accordance with an embodiment, S equal to 1 indicates the start of the subpicture.

According to an embodiment, a subpicture header comprises a field, e.g. 1 bit, which indicates an end of the subpicture. This field may be referred to as the E field. In accordance with an embodiment, E equal to 1 indicates the end of the subpicture.

According to an embodiment, a subpicture header comprises an I field having a length of 1 bit, for example, to indicate whether NAL units followed by the SubpicHdr are the parameter sets required for independent decoding by a separate decoder instance (e.g. when the value of the I field is 1) or not (e.g. when the value of the I field is 0).

According to an embodiment, a subpicture header comprises an A field, e.g. 1 bit, to indicate whether the NAL unit(s) contained in the packet within the scope of the subpicture header is/are applicable to all the subpictures (e.g. when the value of the A field is 1). This can be useful in case of non VCL NAL units that are applicable to the CVS (e.g., SPS, VPS, etc.) or applicable to all the subpictures in the CVS. This can also be helpful to handle a scenario where SubpicHdr is always included in the payload format.

In example embodiments related to FIG. 2a the remaining part RES of the subpicture header (e.g. 2 bits) may be reserved for possible future extensions.

In another embodiment depicted in FIG. 2b, the subpicture header is of 2 octets length with constrained subpicture ID length of 8 bits (instead of the 16 bits as in the example of FIG. 2a).

The details of the subpicture header according to the example of FIG. 2b (henceforth SubpicHdr) are similar to the example of FIG. 2a except that the length of the subpicture ID is shorter (8 bits instead of 16 bits).

In an embodiment, the SubpicHdr will only be included for NAL units which are specific to a subpicture (e.g., VCL NAL units). In-band delivery of NAL units which are applicable to the CVS (e.g., SPS, PPS, VPS) can be delivered without the SubpicHdr.

In another embodiment, the SubpicHdr can be used to indicate relevance to a specific subpicture by including it for VCL as well as non-VCL NAL units. This can be useful for associating or indicating association of parameter sets (SPS, VPS, PPS, APS), SEI messages, etc. with a subpicture.

In the following, the utilization of the subpicture header (SubpicHdr) in different kinds of packets will be described in more detail. In the figures related to these examples the subpicture header is highlighted with a diagonal hash filling, for clarity.

First, an example of a single NAL packetization mode will be discussed with reference to FIG. 3.

FIG. 3 illustrates the use of the subpicture header in a single NAL unit packet, in accordance with an embodiment. In the single NAL unit packet, the subpicture header can either be inserted immediately after the payload header (PayloadHdr) of the NAL unit packet or after a conditional DONL field (a decoding order number of least significant bits), which, when present, specifies the value of the 16 least significant bits of the decoding order number of the contained NAL unit. In case of single NAL unit packet, the selecting forwarding unit SFU can determine the subpicture ID without diving deep into the bitstream. Furthermore, the start and end flag can take care of scenarios to assemble a subpicture comprising multiple slices before delivering it to a separate decoder instance if it intended to be decoded separately from other subpictures. The functionality of assembling the subpicture also facilitates delivering all the dependent subpictures together to the decoder.

In an implementation variation, the subpicture header can also assign one bit to indicate a picture complete flag (P flag). Since the subpicture header is intended to be used only for CVS with at least two subpictures, the S flag and P flag cannot be equal to 1 in the single NAL packet.

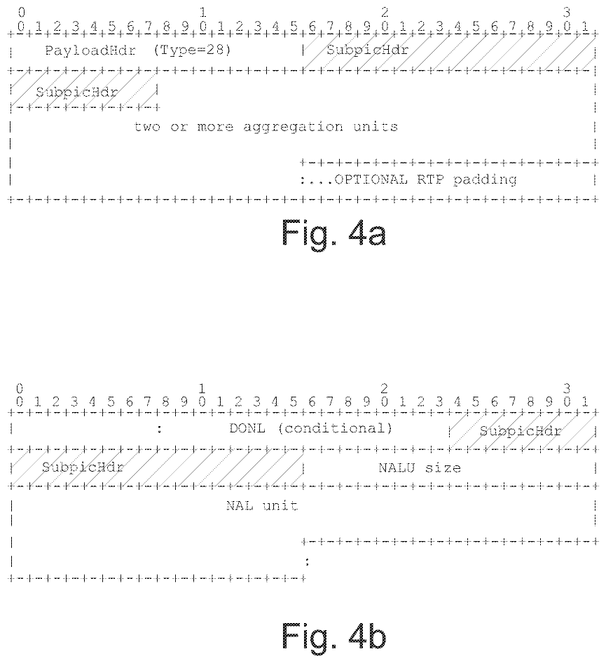

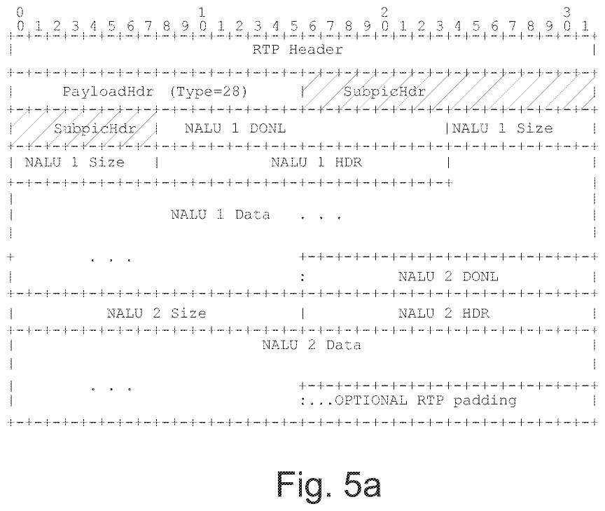

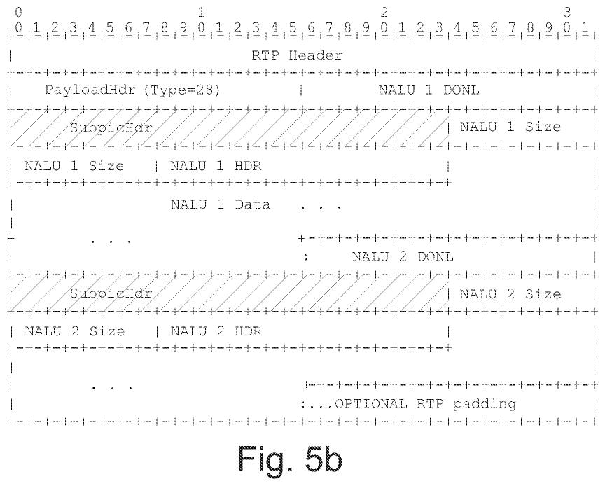

FIGS. 4a and 4b illustrate two implementation embodiments for aggregation packets (AP). In the embodiment of FIG. 4a there is depicted an Aggregation Packet extension in which the subpicture header is included after the payload header with a constraint of having the Aggregation Units (AU) corresponding to the subpicture ID in the subpicture header (i.e. a single subpicture). This can be used to deliver multiple non-VCL or VCL NAL units in-band for each subpicture in a separate aggregation packet. FIG. 5a illustrates an example of the aggregation packet with a single subpicture header and two NAL units.

In the embodiment of FIG. 4b there is depicted an Aggregation Packet extension in which the subpicture header is included after the DONL corresponding to each access unit or NAL unit in the aggregation packet. This can be used to signal non-VCL or VCL NAL units in-band for multiple subpictures in a single aggregation packet. FIG. 5b illustrates an example the aggregation packet having two NAL units and a subpicture header for each of the two NAL units.

In an embodiment, a subpicture header is included in the RTP header extension of an RTP packet containing an Aggregation Packet. The VCL NAL units within the Aggregation Packet may be required to belong to the subpicture indicated in the subpicture header.

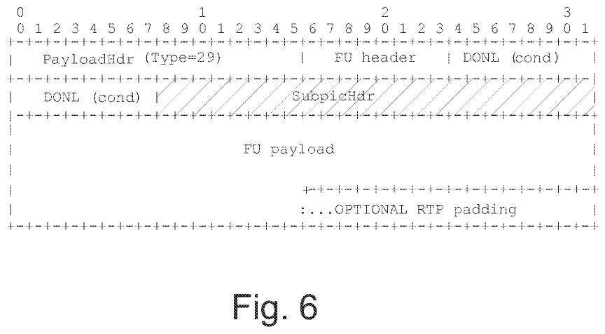

In the following, a fragmentation packet mode will be described with reference to FIG. 6. The fragmentation unit extension with the subpicture header is added only to the first fragmentation unit (FU), i.e. when the start bit in the FU header is equal to 1. The S bit in the subpicture header shall be equal to 1 when the start bit is equal to 1 in FU header, in accordance with an embodiment. However, it should be noted again that instead of the values 1 for the start bit S another value could be used to indicate whether the subpicture header is added to the first fragmentation unit or not.

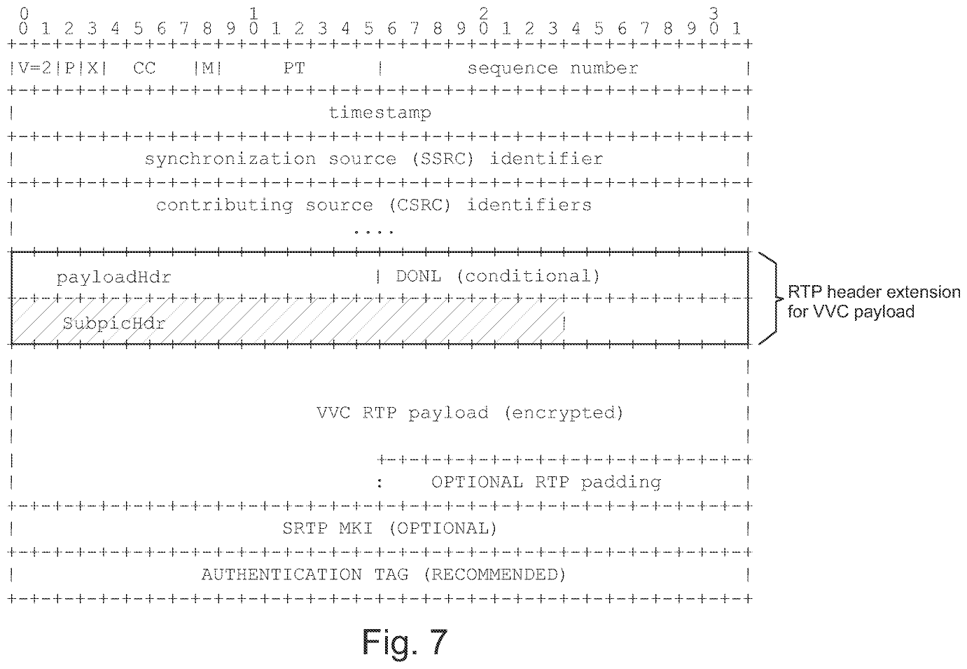

An example RTP packet with encrypted RTP payload is shown in FIG. 7 with unencrypted payload header and subpicture header to enable any receiver (e.g., SFU, MCU, UE, etc.) to determine the subsequent processing or forwarding steps without the need to decrypt the RTP payload.

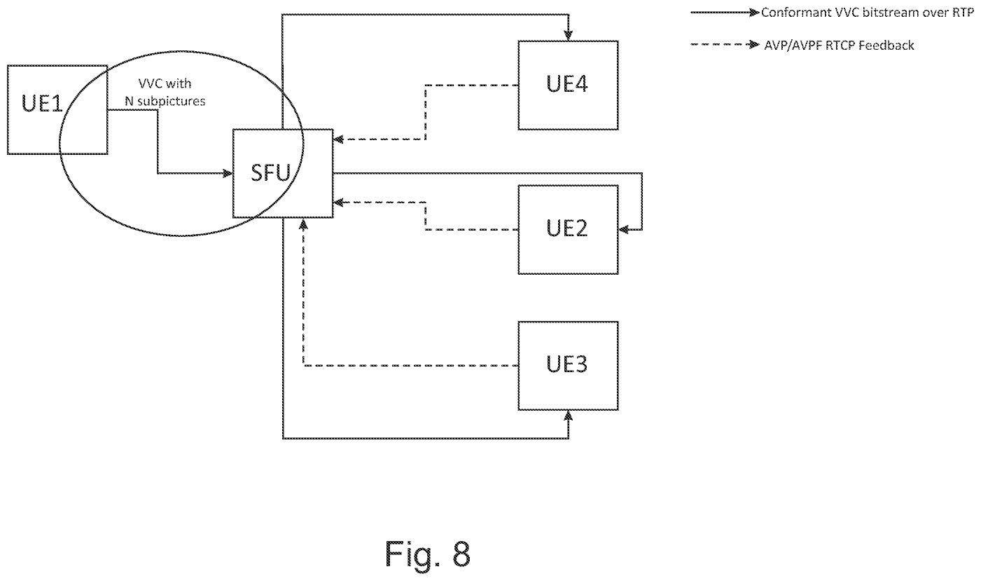

In the following, an example of subpicture header usage in a selective forwarding unit SFU will be described with reference to FIG. 8. FIG. 8 illustrates as a simplified block diagram a scenario where a first user equipment UE1 delivers a coded video sequence CVS (e.g. a VVC video sequence) comprising multiple (N) subpictures to the SFU. The SFU receives the coded video sequence and may store it into a memory. The SFU may also receive one or more requests (e.g., received as RTCP feedback) from another user equipment to deliver one or more parts (e.g. subpictures) of the coded video sequence to the another user equipment. In the example of FIG. 8 there are a second (UE2), a third (UE3) and a fourth user equipment (UE4) illustrated as receiver UEs.

In an embodiment, the SFU receives or determines the subpicture layout of the coded video sequence or bitstream transmitted by the first user equipment. For example, the SFU may receive the subpicture layout from an SPS in the sprop-sps parameter included in the SDP capability negotiation between UE1 and the SFU.

In an embodiment, the SFU determines the subpicture layout of the coded video sequence or bitstream requested to be received from the first user equipment UE1 and includes the subpicture layout in an offer to UE1. In an embodiment, the SFU includes the subpicture layout in an optional MIME parameter, e.g. called subpic-layout. For example, the value of the subpic-layout parameter may be a base64 representation of the syntax elements specifying the subpicture layout and selected other syntax elements of SPS.

The SFU and the receiver user equipment UE2, UE3, UE4 perform SDP capability negotiation, which may comprise, potentially among other things, negotiation which transport protocol to use and properties of the protocol. The SFU may send an offer to each potential receiver or to some of the potential receivers, e.g. to the receiver user equipment UE2, UE3, UE4. The receiver user equipment UE2, UE3, UE4 then sends (an answer to the offer to the SFU in which the receiver user equipment UE2, UE3, UE4 may accept or reject the suggested configuration or if the offer includes several configuration alternatives, the receiver user equipment UE2, UE3, UE4 may select one of these alternative configurations and include information of the selected alternative to the answer for the SFU.

In an embodiment, the offer sent by the SFU to the receiver user equipment UE2, UE3, UE4 comprises the subpicture layout of the bitstream transmitted by UE1. In an embodiment, the SFU includes the subpicture layout in an SPS carried in sprop-sps to the receiver user equipment. In an embodiment, the SFU includes the subpicture layout in an optional MIME parameter, e.g. called subpic-layout. For example, the value of the subpic-layout parameter may be a base64 representation of the syntax elements specifying the subpicture layout and selected other syntax elements of SPS. For example, the value of the subpic-layout parameter may be a base64 representation of the following syntax of VVC SPS:

| | |
|---|---|
| sps_num_subpics_minus1 | ue(v) |
| if( sps_num_subpics_minus1 > 0 ) { | |
| sps_independent_subpics_flag | u(1) |
| sps_subpic_same_size_flag | u(1) |
| } | |
| for( i = 0; sps_num_subpics_minus1 > 0 && i <= sps_num_subpics_minus1; i++ ) { | |
| if( !sps_subpic_same_size_flag \| \| i = = 0 ) { | |
| if( i > 0 && sps_pic_width max_in_luma_samples > CtbSizeY ) | |
| sps_subpic_ctu_top_left_x[ i ] | u(v) |
| if( i > 0 && sps_pic_height_max_in_luma_samples > CtbSizeY ) | |
| sps_subpic_ctu_top_left_y[ i ] | u(v) |
| if( i < sps_num_subpics_minus1 && | |
| sps_pic_width_max_in_luma_samples > CtbSizeY ) | |
| sps_subpic_width_minus1[ i ] | u(v) |
| if( i < sps_num_subpics_minus1 && | |
| sps_pic_height_max_in_luma_samples > CtbSizeY ) | |
| sps_subpic_height_minus1[ i] | u(v) |
| } | |
| if( !sps_independent_subpics_flag) { | |
| sps_subpic_treated_as_pic_flag[ i ] | u(1) |
| sps_loop_filter_across_subpic_enabled_flag[ i ] | u(1) |
| } | |
| } | |

As described above, subpic-layout may indicate receiver capabilities or properties of a stream being transmitted. Alternatively, MIME parameter with different names may be used for each of these mentioned purposes.

In an embodiment, the answer comprises information indicative of which subpicture(s) or subpicture location(s) the receiver user equipment (UE2, UE3, or UE4) requests to receive. For example, the answer may comprise an optional MIME parameter, called subpic-indexes, indicating the subpicture indexes of the subpictures the receiver user equipment requests to receive. The value of subpic-indexes may e.g. be a comma-separated list of base10 representations of subpicture indexes relative to the subpicture layout provided to the user equipment (e.g. as part of the value of the subpic-layout or sprop-sps parameter in the offer). The subpicture index(es) may use a defined numbering scheme, such as the subpicture index as derived in VYC (in subclause 6.5.1 of the VYC standard). In an embodiment, the receiver user equipment (UE2, UE3, or UE4) creates an answer comprising information indicative of which subpicture(s) or subpicture location(s) the receiver user equipment (UE2, UE3, or UE4) requests to receive. In an embodiment, an SFU receives an answer comprising information indicative of which subpicture(s) or subpicture location(s) the receiver user equipment (UE2, UE3, or UE4) requests to receive. After the SDP capability negotiation has been performed, the SFU may translate the feedback received in the answers to bitstream extraction information for each receiver user equipment UE2-UE4.

In an embodiment, the SFU examines the RTP header and the subpicture header, if present, of the RTP packets received from the first user equipment UE1. The SFU may extract subpictures from the received video bitstream based on the presence of the subpicture header in the RTP payload format and based on the received information indicative of which subpicture(s) or subpicture location(s) the receiver user equipment (UE2, UE3, or UE4) requests to receive. This enables either re-directing the received single NAL unit packets, Aggregation Packets, Aggregation Units, and/or Fragmentation Packets to the right destination(s). After extracting the subpictures from the received video bitstream, the SFU may deliver individual subpictures to the receivers which have been indicated that they may utilize the subpictures.

In some implementation embodiments, the SFU/MCU may transform the subpictures extracted with the help of subpicture headers into independently decodable bitstreams. The parameter sets for an independently decodable bitstream may be received in band from the UE1 or generated by the SFU/MCU for subsequent forwarding.

In another embodiment, the SFU function can be described by the following steps. The SFU receives or determines subpicture layout from the coded video sequence from the first user equipment UE1. For example, the SFU may receive an SPS containing the subpicture layout, e.g. through the sprop-sps parameter in the SDP capability negotiation between UE1 and the SFU. The SFU forwards subpicture layout from the first user equipment UE1 to the other user equipment UE2-UE4. For example, the subpicture layout may be forwarded within the value of a subpic-layout parameter or within an SPS included in the sprop-sps parameter in the SDP capability negotiation between the user equipment UE2-UE4 and the SFU. The SFU receives feedback, such as RTCP message(s), from the other user equipment UE2-UE4 which subpicture(s) or subpicture location(s) in the subpicture layout the user equipment UE2-UE4 requests to receive. Then, the SFU may perform bitstream extraction for each of the other user equipment UE2-UE4 and extract subpictures from the received video bitstream. The SFU may perform any required additions, such as adding or creating parameter sets to make the extracted bitstream into independently decodable bitstream. This may require that the SFU is VVC aware to enable creation of parameter sets for independent decoding or bitstream merging. Then, the SFU may deliver individual or merged subpictures as individual subpictures or as a conformant independently decodable VVC bitstream to the receiver user equipment UE2, UE3, UE4.

In the following, two examples of a session negotiation of subpicture header usage will be described.

In the first example the offer and answer indicate the successful negotiation of a session with use of a subpicture header in VVC RTP payload format. The SDP offer comprises format specific parameters as an attribute to the a=fmtp field. In this example the presence of subpic-header-cap indicates that the there is support for the subpicture header and the value of the subpic-header-cap indicates whether there is support for constrained subpicture ID length (constrained subpicture ID length being e.g. 8 bits) or not (e.g. 16-bit subpicture ID). In this example the value of the subpic-header-cap is equal to 0, hence there is no support for constrained subpicture ID length. In the SDP answer the receiver returns the same value for the subpic-header-cap, thus indicating that the receiver does not support constrained subpicture ID length.

```
  SDP offer:
  m=video 49154 RTP/AVP 98 100 99
mid=100
a=tcap:1 RTP/AVPF
a=pcfg:1 t=1
b=AS:950
b=RS:0
b=RR:5000
a=rtpmap:100 H266/90000
a=fmtp:100 profile-id=1; level-id=93; subpic-header-cap=0
  SDP answer:
  m=video 49154 RTP/AVP 98 100 99
mid=100
a-tcap:1 RTP/AVPF
a=pcfg:1 t=1
b=AS:950
b=RS:0
b=RR:5000
a=rtpmap:100 H266/90000
a=fmtp:100 profile-id=1; level-id=93; subpic-header-cap=0
```

The “m=” line indicates that the SFU is offering the video to use plain RTP profile for audio and video conferences with minimal control. The capabilities are provided by the “a=tcap” and “a=pcfg” attributes. The transport capability attribute (“a=tcap”) indicates that RTP under the AVPF profile (“RTP/AVPF”) is supported with an associated transport capability handle of 1. The “a=pcfg” attribute provides the potential configuration included in the offer by reference to the capability parameters. One alternative is provided; it has a configuration number of 1 and it consists of transport protocol capability 1, and the attribute capability 1.

In the second example the offer and answer indicate the successful negotiation of session with use of subpicture header in VVC RTP payload format. The SDP offer comprises format specific parameters as an attribute to the a=fmtp field. In this example the value of the subpic-header-cap indicates whether there is support for constrained subpicture ID length or not. In this example the value of the subpic-header-cap is equal to 1, hence there is support for constrained subpicture ID length. In the SDP answer the receiver does not include the subpic-header-cap attribute to the answer, wherein the SFU can deduce that the receiver does not see the use of the subpicture header and the SFU does not include any subpicture headers to the bitstream for the receiver. This may avoid unnecessary use of the subpicture header.

```
  SDP offer:
  m=video 49154 RTP/AVP 98 100 99
mid=100
a=tcap:1 RTP/AVPF
a=pcfg:1 t=1
b-AS:950
b=RS:0
b=RR:5000
a=rtpmap:100 H266/90000
a=fmtp:100 profile-id=1; level-id=93; subpic-header-cap=1
  SDP answer:
  m=video 49154 RTP/AVP 98 100 99
mid=100
a=tcap:1 RTP/AVPF
a-pcfg:1 t=1
b=AS:950
b=RS:0
b=RR:5000
a=rtpmap:100 H266/90000
a-fmtp:100 profile-id=1; level-id=93
```

Utilizing the subpicture header property the SFU is expected to parse and forward the required subpictures without the need to dig deep into the bitstream. Thus, the subpicture header enables efficient bitstream extraction by an SFU/MCU/MANE.

In an embodiment, the feedback mechanism which subpicture(s) or subpicture location(s) in the subpicture layout a user equipment requests to receive comprises a message comprising one or more subpicture index(es) relative to the subpicture layout provided to the user equipment (e.g. in the value of the subpic-layout or as part of the value of the sprop-sps parameter in the offer). The subpicture index(es) may use a defined numbering scheme, such as the subpicture index as derived in VVC (in subclause 6.5.1 of the VVC standard).

In an embodiment, the feedback mechanism which subpicture(s) or subpicture location(s) in the subpicture layout a user equipment requests to receive comprises a message comprising one or more subpicture ID values.

In some embodiments, the feedback mechanism and the subsequent translation (for deriving the bitstream parts for extraction and merging) may depend on the use case. For example, in case of a multiparty conferencing with 2D rectilinear content, the SFU is tasked to deliver a part of the received video (e.g., a talking head). In this case the receiver feedback can be simply speaker ID (or caller ID). In case of omnidirectional video VDD (viewport-dependent delivery), the RTCP feedback can be viewport orientation and/or viewport dimensions which is translated by the SFU to determine the relevant subpictures. On the other hand, in case of volumetric content the RTCP feedback can be a viewing position and/or orientation of a viewport and/or viewport dimensions of a receiver user equipment (e.g. a direction a user of a head mounted display of a receiver user equipment is looking at) to determine bitstream extraction information by the SFU.

In an embodiment, the feedback mechanism complies with RTP/AVPF. In an embodiment, a feedback message complying with RTP/AVPF for any embodiment above may be specified. For example, a subpicture feedback message may be defined in a manner that it comprises subpicture index(es) relative to the subpicture layout provided to the user equipment a user equipment requests to receive.

In an embodiment, the subpicture header information may further be compressed losslessly by an entropy coding mechanism (e.g. DEFLATE) and its contents can be made compact. In such a case, a compression indicator flag may be signaled in the SDP.

In another embodiment, consecutive subpicture header information in the same RTP packet may be XORed with the first occurrence of the subpicture header and residual information may be run-length coded and signaled as the consecutive subpicture header information. This may result in less number of bits to be signaled. In such a case, a logical operation based run-length coding method may be signaled via the SDP.

In an embodiment of the implementation the subpicture header may carry information about the layout index. The layout of each of the subpictures and the corresponding indices are signaled out-of-band, for example, in SDP or JSON or XML. This layout can be the same as described in the SPS or also include translation information such as mapping information for omnidirectional VDD. This enables the SFU without VVC awareness to perform selective VVC bitstream forwarding.

In the following table, some subpicture header operating point options are disclosed:

| Offer | Answer | Result |
|---|---|---|
| subpic-header-cap[=0] | subpic-header-cap[=0] | Subpicture header |
| | | without subpicture |
| | | ID constraint is |
| | | used. 3 octet header. |
| subpic-header-cap[=0] | Not Present | Subpicture header |
| | | not present. |
| subpic-header-cap=1 | subpic-header-cap=1 | Constrained subpicture |
| | | header is used |
| subpic-header-cap=1 | subpic-header-cap=0 | Subpicture header |
| | | without constrained |
| | | subpicture ID |
| | | constraint is used. |

In an embodiment, in all or some of the examples above, instead of 0 and 1, a boolean variable (TRUE or FALSE) or textual information with the correct character coding method may be used to indicate the attribute or parameter values. For example, subpic-header-cap[=TRUE] may indicate that the subpicture header is used.

The subpicture header capability can be requested by the receiver via a REST API (Representational state transfer application programming interface) in some embodiments. This enables the use of web based session setup procedures while retaining the low latency media delivery with RTP.

In yet another embodiment, the session setup i.e. indication of the media properties regarding the presence of the subpicture header (with default subpicture ID length or constrained length subpicture ID) can be signaled in-band in a control data packet delivered in-band. Such an approach can be useful for content contribution implementations not depending on an out-of-band session setup mechanism. One such example is RUSH introduced as IETF draft.

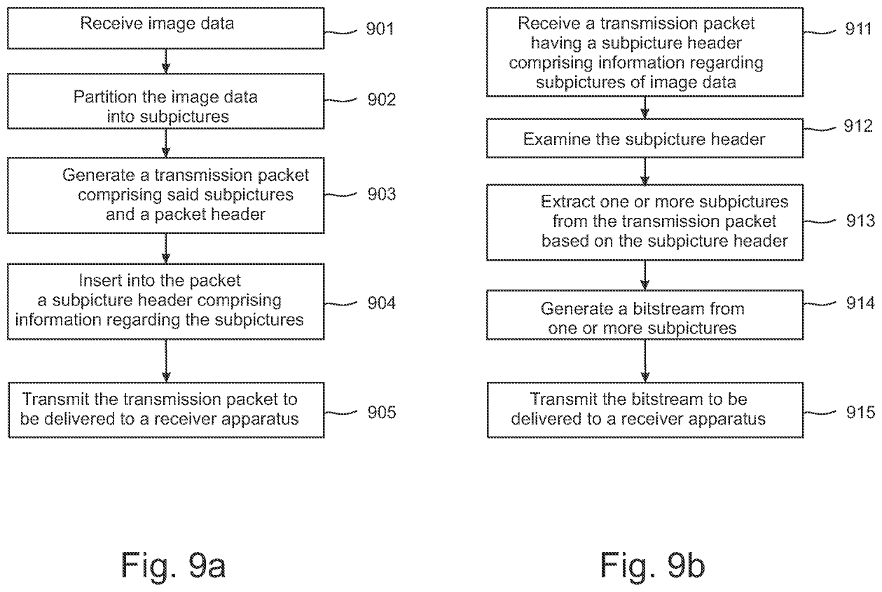

The method for a sender apparatus according to an embodiment is shown in FIG. 9a. The method generally comprises receiving 901 image data, partitioning 902 the image data into subpictures; generating 903 a transmission packet comprising said subpictures and a packet header; inserting 904 into the transmission packet a subpicture header comprising information regarding the subpictures; and transmitting 905 the transmission packet to be delivered to a receiver apparatus. Each of the steps can be implemented by a respective module of a computer system.

The method for a forwarding apparatus according to an embodiment is shown in FIG. 9b. The method generally comprises receiving 911 a transmission packet having a subpicture header comprising information regarding subpictures of image data; examining 912 the subpicture header; extracting 913 one or more subpictures from the transmission packet based on the subpicture header; generating 914 a bitstream from the one or more subpictures; and transmitting 915 the bitstream to be delivered to a receiver apparatus. Each of the steps can be implemented by a respective module of a computer system.

A sender apparatus according to an embodiment comprises means for receiving image data; means for partitioning the image data into subpictures; means for generating a transmission packet comprising said subpictures and a packet header; means for inserting into the transmission packet a subpicture header comprising information regarding the subpictures; and means for transmitting the transmission packet to be delivered to a receiver apparatus.

A forwarding apparatus according to an embodiment comprises means for receiving a transmission packet having a subpicture header comprising information regarding subpictures of image data; means for examining the subpicture header; means for extracting one or more subpictures from the transmission packet based on the subpicture header; means for generating a bitstream from the one or more subpictures; and means for transmitting the bitstream to be delivered to a receiver apparatus.

The means comprises at least one processor, and a memory including a computer program code, wherein the processor may further comprise processor circuitry. The memory and the computer program code are configured to, with the at least one processor, cause the apparatus to perform the method for the sender apparatus and/or the forwarding apparatus according to various embodiments.

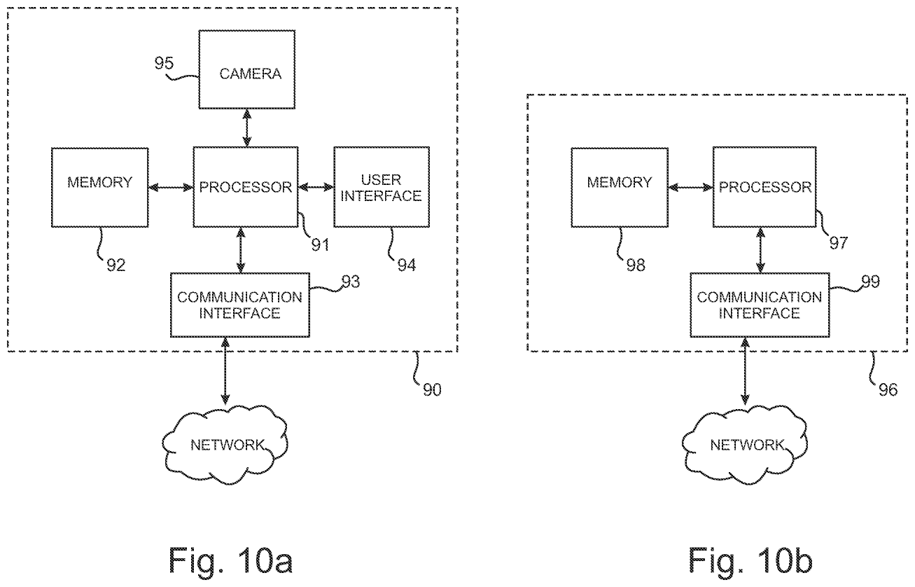

FIG. 10a illustrates an example of a user equipment 90. The user equipment 90 comprises a main processing unit 91, a memory 92, a user interface 94, a communication interface 93. The user equipment 90 according to an embodiment, shown in FIG. 10a, may also comprise a camera module 95. Alternatively, the user equipment 90 may be configured to receive image and/or video data from an external camera device over a communication network. The memory 92 stores data including computer program code in the user equipment 90. The computer program code is configured to implement the method according to various embodiments by means of various computer modules. The camera module 95 or the communication interface 93 receives data, in the form of images or video stream, to be processed by the processor 91. The communication interface 93 forwards processed data, i.e., the image file, for example to a display of another device, such a virtual reality headset. When the user equipment 90 is a video source comprising the camera module 95, user inputs may be received from the user interface. The user equipment 90 is, for example the first user equipment UE1 of FIG. 8, capable for encoding video information into coded video sequences, adding subpictures and subpicture header information into transmission packet for transmitting the coded video sequences. The user equipment 90 may also be the second UE2, third UE3 or the fourth user equipment UE4 of FIG. 8, capable for receiving and decoding video information from coded video sequences delivered by the SFU.

FIG. 10b illustrates an example of an apparatus 96. The apparatus is, for example, the selective forwarding unit SFU for the purposes of the present embodiments. The apparatus 96 comprises a main processing unit 97, a memory 98, and a communication interface 99. The apparatus 96 may be configured to receive image and/or video data from a user equipment 90 by the communication interface 99 from the network and transmit by the communication interface 99 processed video information to other user equipment via the network. The memory 98 stores data including computer program code in the apparatus 96. The computer program code is configured to implement the method according to various embodiments by means of various computer modules.

The various embodiments can be implemented with the help of computer program code that resides in a memory and causes the relevant apparatuses to carry out the method. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of various embodiments.

If desired, the different functions discussed herein may be performed in a different order and/or concurrently with other. Furthermore, if desired, one or more of the above-described functions and embodiments may be optional or may be combined.

In the following, some further examples are described.

According to an example, an apparatus comprises at least one processor; and at least one memory including computer program code the at least one memory and the computer program code configured to, with the at least one processor, cause the apparatus to perform at least the following:
receive image data;
partition the image data into subpictures;
generate a transmission packet comprising said subpictures and a packet header;
insert into the transmission packet a subpicture header comprising information regarding the subpictures; and
transmit the transmission packet to be delivered to a receiver apparatus.

In accordance with an embodiment, the memory of the apparatus comprises computer program code configured to, with the at least one processor, cause the apparatus to perform at least the following:
generate a real time protocol packet comprising an RTP header and an RTP payload header for versatile video coding.

In accordance with an embodiment, the memory of the apparatus comprises computer program code configured to, with the at least one processor, cause the apparatus to perform at least the following:
include the subpicture header in the RTP payload header.

In accordance with an embodiment, the memory of the apparatus comprises computer program code configured to, with the at least one processor, cause the apparatus to perform at least the following:
generate a secure reliable transport protocol packet comprising an SRT header and an SRT payload header.

In accordance with an embodiment, the memory of the apparatus comprises computer program code configured to, with the at least one processor, cause the apparatus to perform at least the following:
generate a frame of a QUIC protocol comprising a RUSH packet and including the subpicture header in the RUSH packet.

In accordance with an embodiment, the memory of the apparatus comprises computer program code configured to, with the at least one processor, cause the apparatus to perform at least the following:
declare usage of the subpicture header as a sender property in a session description protocol.

In accordance with an embodiment, the memory of the apparatus comprises computer program code configured to, with the at least one processor, cause the apparatus to perform at least the following:
include one subpicture in a single transmission packet.

In accordance with an embodiment, the memory of the apparatus comprises computer program code configured to, with the at least one processor, cause the apparatus to perform at least the following:
include one or more of the following indications into the subpicture header:
   a start of the subpicture;
   an end of the subpicture;
   picture complete.

According to an example, an apparatus comprises at least one processor; and at least one memory including computer program code the at least one memory and the computer program code configured to, with the at least one processor, cause the apparatus to perform at least the following:
receive a transmission packet having a subpicture header comprising information regarding subpictures of image data;
examine the subpicture header;
extract one or more subpictures from the transmission packet based on the subpicture header;
generate a bitstream from the one or more subpictures; and
transmit the bitstream to be delivered to a receiver apparatus.

In accordance with an embodiment, the memory of the apparatus comprises computer program code configured to, with the at least one processor, cause the apparatus to perform at least the following:
examine the subpicture header to determine which image data carried by the transmission packet belong to the same subpicture.

In accordance with an embodiment, the memory of the apparatus comprises computer program code configured to, with the at least one processor, cause the apparatus to perform at least the following:
examine the subpicture header to determine which subpictures carried by one or more transmission packets depend from each other; and
collect the dependent subpictures to be delivered together to the receiver apparatus.

In accordance with an embodiment, the memory of the apparatus comprises computer program code configured to, with the at least one processor, cause the apparatus to perform at least the following:
negotiate with the receiver apparatus whether subpicture header functionality is supported by the apparatus, by the receiver apparatus or by both the apparatus and the receiver apparatus.

In accordance with an embodiment, the memory of the apparatus comprises computer program code configured to, with the at least one processor, cause the apparatus to perform at least the following:
prepare an offer;
include in the offer indication whether subpicture header functionality is supported by the apparatus;
send the offer to the receiver apparatus;
receive an answer from the receiver apparatus; and
examine whether the answer indicates whether subpicture header functionality is supported by the receiver apparatus.

While various embodiments and examples have been described above with reference to the term subpicture, it needs to be understood that embodiments and examples equally apply to any picture partitioning concept similar to subpicture (as defined in VVC), such as an isolated region or an MCTS.

Some embodiments and examples have been described in relation to syntax and semantics. It needs to be understood that the embodiments and examples apply to any apparatus or computer program code generating a signal according to the syntax and the semantics. It needs to be understood that the embodiments and examples apply to any apparatus or computer program code decoding a signal according to the syntax and the semantics.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

1-16. (canceled)

17. An apparatus comprising:
at least one processor; and
at least one non-transitory memory including computer program code;
the at least one non-transitory memory and the computer program code configured to, with the at least one processor, cause the apparatus at least to receive an image data;
partition the image data into subpictures;
generate a transmission packet comprising the subpictures and a packet header;
insert a subpicture header into the transmission packet, wherein the subpicture header comprises information regarding the subpictures; and
transmit the transmission packet to be delivered to a receiver apparatus.

18. The apparatus according to claim 17, wherein the subpicture header comprises one or more of following fields:
an identifier of a subpicture;
a type of the subpicture;
an indication of a start of the subpicture;
an indication of an end of the subpicture;
an indication whether network abstraction layer (NAL) units followed by the subpicture header are parameter sets required for independent decoding by a separate decoder instance;
an indication whether an NAL unit is applicable to the subpictures in a coded video sequence; or
an indication of a last subpicture for an access unit.

19. The apparatus according to claim 17, wherein to generate the transmission packet, the apparatus is caused to generate a real time protocol packet comprising an real-time transport protocol (RTP) header and an RTP payload header for versatile video coding.

20. The apparatus according to claim 19, wherein to insert the subpicture header into the transmission packet, the apparatus is caused to include the subpicture header in the RTP payload header.

21. The apparatus according to claim 17, wherein apparatus is further caused to: declare usage of the subpicture header as a sender property in a session description protocol.

22. The apparatus according to claim 17, wherein to generate the transmission packet, the apparatus is caused to:
include one subpicture in a single transmission packet.

23. The apparatus according to claim 22, wherein the apparatus is further caused to:
include one or more of following indications into the subpicture header:
a start of the subpicture;
an end of the subpicture; or
a picture complete.

24. The apparatus according to claim 17, wherein the apparatus is caused to operate in one of following packetization modes:
a single NAL packetization mode, wherein the transmission packet comprises a slice of one subpicture;
an aggregation packet mode, wherein the transmission packet comprises an aggregation packet for each subpicture or the aggregation packet comprises multiple subpictures; or
a fragmentation packet mode, wherein the subpicture header is included to a first fragmentation unit.

25. A method comprising:
receiving an image data;
partitioning the image data into subpictures;
generating a transmission packet comprising said subpictures and a packet header;
inserting a subpicture header into the transmission packet, wherein the subpicture header comprises information regarding the subpictures; and
transmitting the transmission packet to a receiver apparatus.

26. An apparatus comprising at least one processor; and
at least one non-transitory memory including computer program code;
the at least one non-transitory memory and the computer program code configured to, with the at least one processor, cause the apparatus at least to:
receive a transmission packet having a subpicture header comprising information regarding subpictures of an image data;
examine the subpicture header;
extract one or more subpictures from the transmission packet based on the subpicture header;
generate a bitstream from the one or more subpictures; and
transmit the bitstream to a receiver apparatus.

27. The apparatus according to claim 26, wherein the apparatus is further caused to:
examine the subpicture header to determine which image data carried by the transmission packet belong to the same subpicture.

28. The apparatus according to claim 26, wherein the apparatus is further caused to:
examine the subpicture header to determine which the subpictures carried by one or more transmission packets depend from each other; and
collect dependent subpictures to be delivered together to the receiver apparatus.

29. The apparatus according to claim 26, wherein the apparatus is further caused to:
negotiate with the receiver apparatus whether a subpicture header functionality is supported by the apparatus, by the receiver apparatus or by both the apparatus and the receiver apparatus.

30. The apparatus according to claim 29, wherein to negotiate, the apparatus is caused to:
prepare an offer;
include in the offer, an indication whether the subpicture header functionality is supported by the apparatus;
send the offer to the receiver apparatus;
receive an answer from the receiver apparatus; and
examine whether the answer indicates whether the subpicture header functionality is supported by the receiver apparatus.

31. The apparatus according to claim 26, wherein the apparatus is further caused to:
indicate a subpicture layout to the receiver apparatus; and
receive feedback from the receiver apparatus which subpictures of the subpicture layout are requested to be the one or more subpictures for extracting.

32. A method comprising:
receiving a transmission packet having a subpicture header comprising information regarding subpictures of an image data;
examining the subpicture header;
extracting one or more subpictures from the transmission packet based on the subpicture header;
generating a bitstream from the one or more subpictures; and
transmitting the bitstream to a receiver apparatus.

33. The method to claim 32 further comprising:
examining the subpicture header to determine which the image data carried by the transmission packet belong to the same subpicture.

34. The method to claim 32 further comprising:
examining the subpicture header to determine which subpictures carried by one or more transmission packets depend from each other; and
collecting dependent subpictures to be delivered together to the receiver apparatus.

35. The method according to claim 32 further comprising:
negotiating with the receiver apparatus whether a subpicture header functionality is supported by an apparatus, by the receiver apparatus or by both the apparatus and the receiver apparatus.

36. The method according to claim 35, wherein the negotiating comprising:
preparing an offer;
including in the offer, an indication whether the subpicture header functionality is supported by the apparatus;
sending the offer to the receiver apparatus;
receiving an answer from the receiver apparatus; and
examining whether the answer indicates whether the subpicture header functionality is supported by the receiver apparatus.
